(19) United States
(12) Patent Application Publication
(10) Pub. No.: US 2007/0060352 A1
(43) Pub. Date: Mar. 15, 2007

(54) Gaming machine with color-coded buttons

(76) Inventor: Joseph W. Cole, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/243,385

(22) Filed: Oct. 4, 2005

Related U.S. Application Data
(63) Continuation-in-part of application No. 11/223,083, filed on Sep. 9, 2005.

(51) Int. Cl. A63F 13/00

(52) U.S. Cl. 463/37

(57) ABSTRACT

Input devices, such as push-buttons, are configured to display different colors, such as by emitting light in different colors. The displayed colors of the input devices are controlled so that a user may differentiate them and their associated functions. In one use, a gaming machine includes a plurality of color-codeable player input buttons. Buttons of a gaming machine which are used in active play of a game are configured to display a first color, such as by emitting green light, while inactive buttons are configured to display a second color, such as by emitting red light. When the input device is a push-type button, the displayed color may depend upon a color of a push-button cover, a plate associated with the cover, and/or the color of light emitted by a lamp of the button.

### RELATED APPLICATION DATA

This application is a continuation-in-part of U.S. application Ser. No. 11/223,083, filed Sep. 9, 2005.

### FIELD OF THE INVENTION

The present invention relates to push-buttons and other types of input devices used with gaming and similar machines.

### BACKGROUND OF THE INVENTION

In the past, gaming machines were generally custom-configured to present a particular game. For example, a gaming machine would have one configuration when used to presenting a slot-type game, and another configuration when used to present a video poker game. When configured to present a slot-type game, the gaming machine might include rotatable reels and one or more buttons for initiating the game, such as a “spin” button. When configured to present a video-poker type game, the gaming machine might include a video display and a plurality of buttons permitting a player to make “hold” or “draw” selections relative to each of a number of displayed cards.

Casinos like to offer as many different games as possible in order to appeal to the maximum number of players. Unfortunately, casino floor space is limited. Further, gaming machines are very expensive, and it is often cost-prohibitive to produce custom gaming machines which present games which only appeal to smaller numbers of players.

As an attempt to address these issues, some gaming machines are being configured to present a plurality of games. Generally, however, because the physical configuration of the gaming machine is static, these gaming machines are limited to presenting games which are all similar and which can be implemented via the same physical configuration of the machine. For example, a gaming machine may be configured with multiple “hold/draw” buttons. The gaming machine may then be used to present various versions of the game of video poker (such as “Deuces Wild” or “Jacks or Better”). However, since the physical configuration of the gaming machine is specifically arranged for that purpose, the gaming machine is still not suited to presenting other types of games.

### SUMMARY OF THE INVENTION

The invention is a configurable input device. One aspect of the invention is an input device where information which is displayed to a user can be changed. Another aspect of the invention is input devices which are color-coded.

In one embodiment, the input device comprises a user-engageable member connected to a signal generator, the user-engageable member moveable between a first position and a second position, movement of which causes the signal generator to output at least one signal. At least a first element of information, such as text, logo or graphics, is associated with the input device, that first element of information having an attribute of a first color. At least a second element of information is also associated with the input device, that second element of information having an attribute of a second color different from the first color.

At least one illumination device associated with the user-engageable member is configured to illuminate the first and second information in a manner causing that information to be selectively readable or visible. In one embodiment, the at least one illumination device is capable of emitting light in the first color and the second color. When the illumination device emits light of the first color, only the second information in the second color is visible. When the illumination device emits light of the second color, only the first information in the first color is visible.

In one embodiment, the input device is a push-button type electrical switch. The push-button switch has a body, an actuator mounted for movement relative to the body, a button cover mounted to the actuator and extending there from for engagement by a user, and an electrical switch for actuation by the actuator. The at least first and second information is preferably associated with the button cover, such as by being printed on the cover or on an insert located adjacent the cover.

In this embodiment, the at least one illumination device illuminates the information associated with the button cover. One or more LEDs, each configured to emit light of one of the first, second or other colors, may be mounted within the body under the button cover.

In one embodiment, the input device is associated with a gaming machine. The configuration of the input device(s) of the machine may be changed depending upon the game presented by the gaming machine. In particular, the at least one illumination device of each input device is controlled so that the particular information displayed thereby corresponds to a function of the gaming machine. For example, an input from the input device may correspond to a first function of a first game presented by the machine (such as a “spin” function of a slot-type game) and a second function of a second game presented by the machine (such as a “hold” or “draw” function of a video poker game). In this manner, the one or more input devices may be controlled and configured to display particular information to a user, and that displayed information may be varied or changed depending upon a game or other function of the gaming machine.

Another aspect of the invention is color-coded input devices. An input device, such as a push-button, is configured to display at least one of two different colors. The input device may be configured to display different colors by emitting light in two different colors, such as by use of one or more lamps and/or, in the case of a push-button, a color of a push-button cover or associated plate.

In a method of the invention, the color displayed by the input device is associated with a corresponding function. In the case of a gaming machine, for example, input devices which are used in active play of the game may be configured to display the color green, while input devices which are not used in play of the game may display the color red.

In a preferred embodiment, the displayed color may be varied or changed over time as the associated function of the input device changes. For example, a gaming controller may transmit control signals which cause the input device displayed color(s) to change depend upon a particular game selected for play by a player.

Further objects, features, and advantages of the present invention over the prior art will become apparent from the detailed description of the drawings which follows, when considered with the attached figures.

### DESCRIPTION OF THE DRAWINGS

FIG. 1 is a side view of an input device of the present invention, the device comprising a push-button electrical switch mounted to a support structure in the form of a gaming machine housing;

FIG. 2 is an exploded view of the push-button electrical switch illustrated in FIG. 1;

FIG. 3 illustrates one embodiment of a button cover of the push-button electrical switch illustrated in FIG. 1;.

FIG. 4 illustrates another embodiment of a button cover of the push-button electrical switch illustrated in FIG. 1;

FIGS. 5(a)-(c) illustrate a push-button electrical switch of the present invention configured to present first, second and third information;

FIG. 6 illustrates application of input devices of the invention configured for play of a first game at a gaming machine;

FIG. 7 illustrates application of input devices of the invention configured for play of a second game at the gaming machine illustrated in FIG. 6;

FIG. 8 illustrates color-coded input devices in accordance with another embodiment of the invention;

FIG. 9A illustrates one configuration of a color-coded input device in accordance the invention; and

FIG. 9B illustrates another configuration of a color-coded input device in accordance with the invention.

### DETAILED DESCRIPTION OF THE INVENTION

The invention is a configurable input device. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a user input device which may be configured to display different information. In one embodiment, the input device is associated with a gaming or similar machine, and the information which is displayed by the input device is associated with or dependent upon a function of the machine. The information which is displayed may be varied depending upon the associated function.

In one embodiment, different elements of information are associated with the input device in different colors. Which of the information is visible to the user of the device is dependent upon a color or colors of light transmitted to the information.

In a preferred embodiment, the input device is a push-button type electrical switch. The switch includes a push-button for actuating an electrical switch. The push-button electrical switch is configured to display information to a user thereof, such as text indicating the function with which the push-button electrical switch is associated. In a preferred embodiment, the push-button electrical switch can be associated with different functions and can thus be configured to display different information to the user. The push-button electrical switch has particular applicability to use with a gaming machine, whereby the information displayed by the switch can be varied depending upon the game which is presented by the machine.

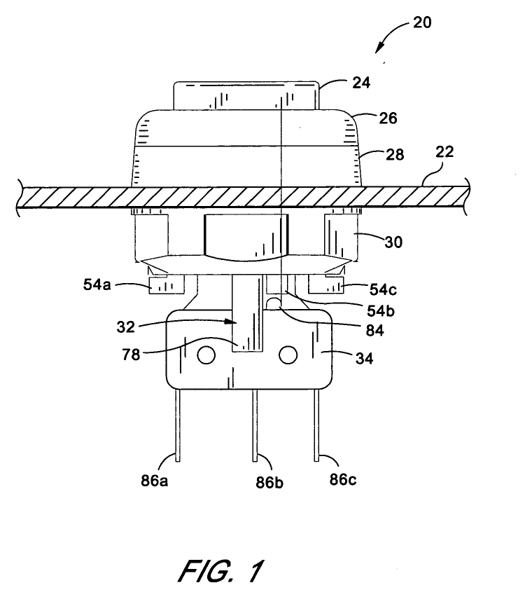

One embodiment of a push-button electrical switch 20 of the invention will first be described generally with reference to FIG. 1. As illustrated, the push-button electrical switch 20 may be mounted to a support structure. In a preferred embodiment, the support structure is a panel or housing 22 of a gaming machine.

In one embodiment, the push-button electrical switch 20 includes a push-button lens cap or “button cover” 24 extending from a top portion or end of a button body or housing 26. The body or switch includes an adapter 28 and lock nut 30. As illustrated, the adapter 28 and lock nut 30 are associated with an exterior portion of the body 26. The adapter 28 may be formed integral with the body 26. A lamp/switch mount 32 is connected to the body 26 and extends from a bottom portion or end thereof generally opposite the push-button lens cap 24. A signal generator in the form of an electrical switch 34 is connected to the lamp/switch mount 32.

In the arrangement illustrated, the housing 22 comprises a metal panel forming a portion of a body or housing of the gaming machine. The housing 22 has an aperture therethrough. Preferably, the body 26 extends through the aperture. The aperture is larger than the portion of the body 26 which extends therethrough, but is smaller in dimension than the adapter 28. The adapter 28 is positioned over the body 26 adjacent a top side of the housing 22, obscuring the aperture through which the body extends. The lock nut 30 is affixed to the body 26 from the bottom side of the housing 22. In this manner, the housing 22 is positioned between the adapter 28 and the lock nut 30, securing the push-button electrical switch 20 to the housing 22.

As detailed below, the push-button lens cap 24 extends outwardly from the body 26 for engagement by a user thereof, such as by a player of the gaming machine. When depressed or pushed by a user, the push-button lens cap 24 is arranged to activate/actuate the electrical switch 34. Leads extend from the electrical switch 34, and wires may be connected to the leads and extend to another device, whereby the signal from the electrical switch 34 is used as an input to that device.

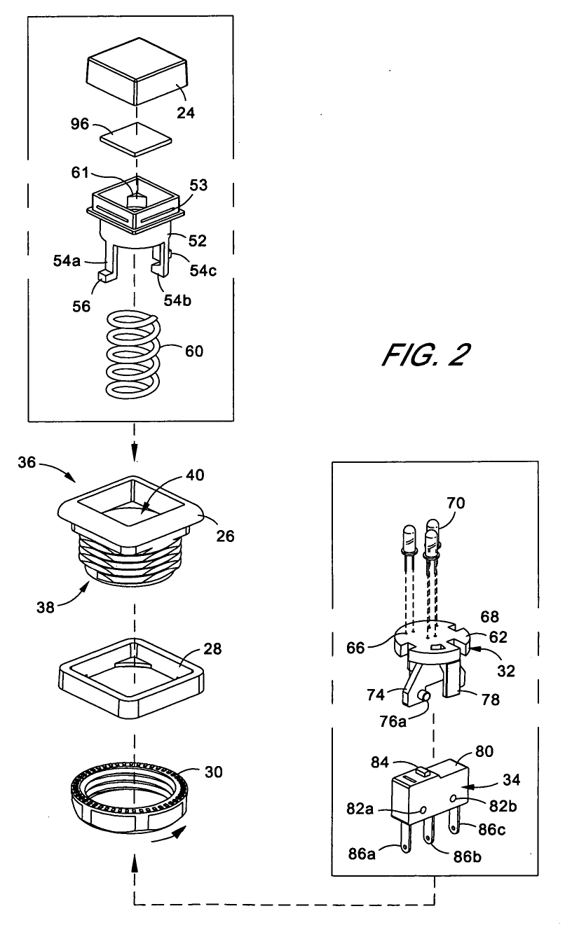

The components and construction of one embodiment of the push-button electrical switch 20 will now be described in detail. As illustrated in FIG. 2, the body 26 serves a supporting/housing function and includes a wall having inner and outer surfaces. In one embodiment, the body 26 is generally tubular and has a top or proximal end 36 and a bottom or distal end 38. A passage 40 extends through the body 26. As illustrated, at its top end 36, the body 26 is generally square, thus defining a generally square periphery of the passage 40. The body 26 may have a variety of other shapes at this location, such as round or rectangular. Preferably, the bottom end of 38 of the body 26 is generally cylindrical, thus defining a generally circular periphery of the passage 40 at that location.

In one or more embodiments, an outer surface of the body 26 is threaded at its bottom end 38. The threads extend upwardly towards the top end 36. The threads are adapted to accept mating threads on the lock nut 30.

The body 26 is configured to accept at least a portion of the push-button lens cap 24. As illustrated, when the push-button lens cap 24 is generally square in peripheral shape, so is at least the top portion of the passage through the body 26. As described above, the body 26 defines a periphery around the top portion of the passage 40 which is also generally square. As illustrated, the body 26 includes an outwardly extending flange in this location. As noted above, the push-button lens cap 24 may be other than square, in which case the body 26 at this location is as well, for example round or rectangular.

Below the top portion of the passage 40, the passage is preferably cylindrical in shape, and has a diameter which is less than the maximum dimension of the top portion of the passage 40. As a result of the change in size and shape of the passage 40, a ledge is defined. As detailed below, the ledge serves as a stop to limit the travel of the push-button lens cap 24 downwardly into the body 26, and serves as a support for a spring.

As described above, a push-button lens cap 24 is associated with the body 26, and preferably is located at the top end 36 thereof. At least a portion of the push-button lens cap 24 is adapted to extend from the top end 36 of the body 26 for engagement by a user. Referring to FIG. 2, the push-button lens cap 24 comprises a generally square member having a top surface and one or more sides or members extending downwardly therefrom. The push-button lens cap 24 may have a variety of other shapes, including rectangular and circular.

The push-button lens cap 24 is associated with an actuator 52. The actuator 52 has a first end shaped to accept the push-button lens cap 24 there over. When the push-button lens cap 24 is square, preferably so is the first end of the actuator. Likewise, when the push-button lens cap 24 has other shapes such as rectangular or circular, the first end of the actuator 52 may be as well. Notably, the first end of the actuator 52 and the push-button lens cap 24 need not be the same shape, as long as the connecting function between the two is facilitated. As illustrated, one or more tabs 53 are located on the outside of the first end of the actuator 52 for use in securing the push-button lens cap 24 to the actuator 52.

The actuator 52 has a generally cylindrical main portion adapted to fit within the cylindrical portion of the passage 40 through the body 26. Preferably, three legs 54a,b,c extend downwardly from the periphery of the main portion of the actuator 52 in a direction opposite its first end. A pair of the legs 54a,54c are preferably located about 180 degrees apart. The third leg 54b is positioned there between. As illustrated, the third leg 54b is preferably located nearer one of the legs 54c than the other of the legs 54a.

The opposing legs 54a,54c each have a catch 56 extending outwardly therefrom. Preferably, each catch 56 extends in a direction generally radially out in a direction perpendicular to an axis extending through the actuator. Referring to FIG. 1, when the actuator 52 is positioned in the body 26, the legs 54a,b,c extend through spaces between the stop defined by the body 26. When so positioned, the catches 56 engage a lower rim of the body 26, preventing further upward movement of the actuator 52.

A foot is located on the end of the third leg 54b. As described in more detail below, the foot is adapted to engage a button of the electrical switch 34 for actuating the switch. As illustrated in FIG. 2, the foot extends radially inward from the third leg 54b.

A spring 60 is positioned inside of the body 26 and engages both the body 26 and the actuator 52. In a preferred embodiment, the spring 60 is a helical spring. A first end of the spring 60 rests against the top surface of the stop defined by the body 26. The second end of the spring 60 is positioned within the actuator 52 and rests against a stop 61 therein. So arranged, the spring 60 has the natural tendency to urge the actuator 52 upwardly to the point where further upward travel is limited by the catches 56. The urging of the actuator 52 upwardly also urges the push-button lens cap 24 attached thereto upwardly. When pressed by a user, the push-button lens cap 24 moves the actuator 52 downwardly against the biasing force of the spring 60, compressing the spring.

The lamp/switch mount 32 is connected to the body 26 at its bottom end 38. The lamp/switch mount 32 has a generally disc-shaped main portion 62. The main portion 62 has three cut-out areas extending into the perimeter thereof, which areas permit passage of the legs 54a,b,c of the actuator 52 therethrough.

The push-button switch 20 includes at least one illumination device. As described below, the illumination device is configured to illuminate information associated with the switch 20.

In one embodiment, the main portion 62 of the lamp/switch mount 32 is configured to support at least one illumination device in the form of one or more lamps 70. As described below, in a preferred embodiment, the one or more lamps 70 are configured to emit light in at least two distinct colors. In one embodiment, a single lamp 70 may be configured for this purpose. For example, a single LED which is capable of emitting two, three or more colors of light may be utilized. In another embodiment, as illustrated in FIG. 2, a plurality of lamps 70a,b,c are used for this purpose.

In a preferred embodiment, the lamp or lamps each comprise an LED light. The lamp(s) 70 may have other configurations, however, such as an incandescent bulb or the like.

The main portion 62 of the lamp/switch mount 32 preferably includes a socket or mount for the one or more lamps 70. For example, in the version illustrated in FIG. 2, the main portion 62 may include three “two-pin” mounts for accepting the electrical pins of three corresponding LEDs 70. Of course, the type of mount/socket may vary depending upon the type of lamp(s) 70 which are utilized. For example, sockets including contacts may be utilized for incandescent lamps. Though not illustrated, electrical connections lead from the one or more sockets or mounts by which power may be selectively provided to the one or more lamps 70 for selectively illuminating them.

A switch mount 74 extends below the main portion 62 of the lamp/switch mount 32. The switch mount 74 is offset from the central axis. In one embodiment, the switch mount 74 extends from the lamp stand 68. The switch mount 74 includes first and second spaced pins 76 (only one of which is visible in FIG. 2). A lock 78 extends downwardly from the main portion 62. The lock 78 is spaced apart from the pins 76, defining a space in which the electrical switch 34 may be located.

Referring to FIG. 2, the electrical switch 34 has a generally closed housing 80. The electrical switch 34 may have a variety of shapes and configurations. As illustrated, the housing 80 is generally rectangular. First and second passages 82a,82b extend through the housing 80 from side to side. The passages 82a,b are adapted to accept the lock pins 76 of the lamp/switch mount 32.

A button 84 extends upwardly from a top surface of the housing 80. The button 84 preferably actuates an electrical switch within the electrical switch 34. In one embodiment, the electrical switch 34 is a two-position switch. The workings of such electrical switches 34 are well known. As is common in such a two-position electrical switch 34, the electrical switch 34 includes three leads or contacts 86a,b,c. The position of the electrical switch 34 determines which of the leads are “hot” (one being for ground).

When the electrical switch 34 is mounted to the lamp/switch mount 32 the pins 76 extend into the passages 82a,b. The lock 78 presses against the opposite side of the housing 80 of the electrical switch 34, maintaining the pins 76a,b in engagement with the passages 82a,b, securely mounting the electrical switch 34.

When so mounted, the foot of the second leg 54b of the actuator 52 is positioned adjacent the button 84 of the electrical switch 34. When a user depresses the push-button lens cap 24, the actuator 52 is moved downwardly, causing the foot to engage the switch button 84. This actuates the electrical switch 34.

In the embodiment illustrated, the lamp/switch mount 32 is arranged to be mounted in abutting relationship to the stop(s) at the bottom end 38 of the body 26. The top surface of the main portion 62 of the lamp/switch mount 32 is abutted against the lower surface of the stop(s) of the body 26 (i.e. on the side thereof opposite the spring 60). In this position, one latch which extends downwardly from the stop(s) of the body 26 preferably extends through a passage in the lamp/switch mount 32, with the catch of the latch engaging the lower portion of the main portion 62 of the lamp/switch mount 32. At the same time, another latch which also extends downwardly from the body, extends along a cut-out area in the main portion 62 of the lamp/switch mount 32, with the catch thereof also engaging the lower portion of the main portion 62 of the lamp/switch mount 32.

The various components of the push-button electrical switch 20 may be constructed from a wide range of materials. In one embodiment, the push-button lens cap 24, actuator 52, body 26, adapter 28, lock nut 30, and lamp/switch mount 32 comprise plastic or a similar material conveniently constructed in a molding or extrusion process. In one or more embodiments, the various components may have a variety of colors.

The push-button type electrical switch 20 is configured to display information to a user thereof. Preferably, this information pertains to the function with which the switch 20 is associated. For example, in the case of a gaming machine such as described below, the push-button electrical switch 20 may be associated with a “hold” or “draw” function. In particular, activation of the electrical switch 20 by a user in that case preferably causes the gaming machine to accept input that a particular card is to be held or replaced.

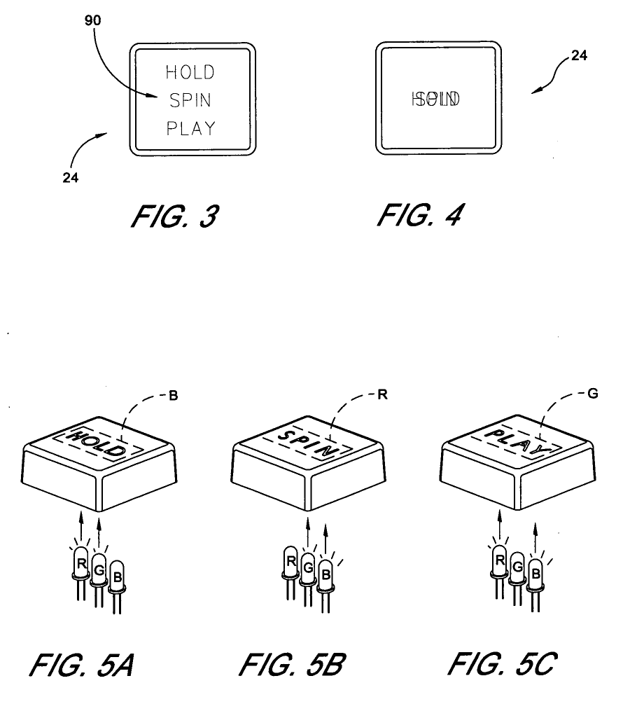

In the preferred embodiment, the push-button electrical switch 20 can be configured to display different information, such as depending upon the function with which the switch 20 is associated. In one embodiment, as best illustrated in FIGS. 3 and 4, information 90 is associated with the button cover 24. The information 90 may vary, and may comprise text and/or graphics such as images, logos or the like. For example, the information 90 may comprise text such as the words “spin,” “hold,” or “play,” as illustrated in FIG. 3. The information 90 might alternatively or additionally comprise images such as a symbol for “spin” or the like.

In a preferred embodiment, the information 90 which is displayed by the push-button electrical switch 20 may be selectively varied. In a preferred embodiment, this is accomplished by changing the color of the light emitted by the one or more lamps 70 of the switch 20, relative the color of the information associated with the switch 20.

In a preferred embodiment, at least two elements of information are associated with the button cover 24. The two elements of information are preferably printed in two different colors or otherwise have two different color attributes. For example, referring to FIG. 3, the word “hold” may be printed in a first color, the word “spin” in a second color, and the word “play” in a third color. Preferably, as detailed below, the colors of the information are selected relative to colors of light which may be emitted by the one or more lamps 70.

The information 90 may be associated with the button cover or lens cap 24 in a variety of fashions. In one embodiment, the information 90 may be directly printed upon the lens cap 24. The information 90 might also be associated during a molding processing by which the cap 24 is formed. The information 90 might also be indirectly associated, such as by locating a sticker bearing the information 90 on the cap 24, or by locating the information on a legend plate 96 (see FIG. 2) which is located adjacent the cap 24.

Referring to FIG. 3, the information 90 may be associated with the lens cap 24 in different locations. In another embodiment, as illustrated in FIG. 4, various information 90 may be in the same location on the lens cap 24, such as printed in the center thereof.

Preferably, the color of the information 90 and the color(s) of light emitted by the one or more lamps 70 are selected so that particular of the information 90 can be selectively made visible to the user of the switch 20. An example of this configuration will be described with reference to FIGS. 5(a)-(c). As illustrated therein, a lens cap 24 is printed with the text “HOLD” in the color blue, “SPIN” in the color red, and “PLAY” in the color green. In addition, three lamps 70 are provided, the lamps 70 configured to emit light in the colors red, green and blue.

Referring to FIG. 5(a), when the “red” and “green” lamps 70 are activated, those lamps 70 emit red and green light, effectively making the “SPIN” and “PLAY” text invisible or unreadable to the user of the switch. On the other hand, the “HOLD” text, which is in blue, is visible. As such, at that time, the switch 20 is configured to display the text “HOLD.”

Referring to FIG. 5(b), when the “green” and “blue” lamps 70 are activated, those lamps 70 emit green and blue light, effectively making the “HOLD” and “PLAY” text invisible or unreadable to the user of the switch. On the other hand, the “SPIN” text, which is in red, is visible. As such, at that time, the switch 20 is configured to display the text “SPIN.”

Referring to FIG. 5(c), when the “red” and “blue” lamps 70 are activated, those lamps 70 emit red and blue light, effectively making the “HOLD” and “SPIN” text invisible or unreadable to the user of the switch. On the other hand, the “PLAY” text, which is in green, is visible. As such, at that time, the switch 20 is configured to display the text “PLAY.”

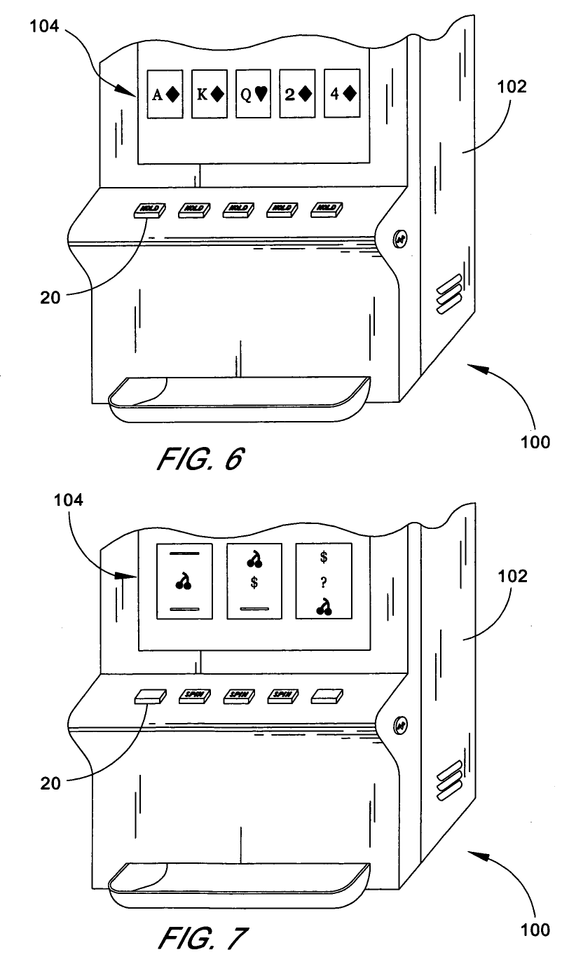

The configurable switch 20 of the invention has particular utility to a gaming machine. FIGS. 6 and 7 illustrates a gaming machine 100 configured to present one or more games to a player thereof. In a preferred embodiment, the gaming machine 100 is a wagering type machine, in which a player is required to place a bet and which, upon the occurrence of a predetermined winning event or events, entitles the player to prizes or winnings. As illustrated, the gaming machine 100 includes a housing 102 for enclosing/supporting various components of the gaming machine. The gaming machine 100 includes a display 104 for displaying images of cards or other indicia for use in playing the game. Speakers (not shown) or other devices may be provided for generating sound associated with the game.

Though not shown, the gaming machine 100 may include a bill validator/acceptor for accepting paper currency and/or a coin acceptor for accepting coins. Other means of payment, such as a credit card reader may be provided. An award of winnings in the form of coins may be paid to the player via a coin tray. The gaming machine 100 may include a card reader for reading a player tracking card or the like, as is known in the art.

A game controller (not shown) is provided for controlling the various devices of the gaming machine and for providing game information. For example, the game controller may be arranged to generate video and audio data for presentation by the display and speakers of the gaming machine 100. The game controller may be arranged to detect a signal from the coin acceptor indicating the receipt of coins, and may be arranged to cause a coin delivery mechanism to deliver coins from a coin hopper to the coin tray.

It will be appreciated that the gaming machine 100 may have a variety of configurations and the gaming machine 100 illustrated and described above is but an example of a device. In one or more embodiments, the gaming machine 100 may be associated with a network and receive game information remotely and may transmit information, such as payout and game play information, to a remote location.

Preferably, the gaming machine 100 includes means for a player to provide input. In one embodiment, this means comprises one or more buttons. Preferably, one or more of these buttons comprise push-button type electrical switches 20 in accordance with the present invention.

In the example illustrated in FIGS. 6 and 7, the gaming machine 100 includes at least five (5) such push-button switches 20. In accordance with the invention, the gaming machine 100 is configured to present various different games. For example, the video display 104 may be used to present information regarding a card game, such as poker, or to present images of simulated rotatable reels, in the case of a slot-type game.

Referring to FIG. 6, when a poker type game is presented, the push-button switches 20 may be configured to display information relative to poker game inputs. For example, if the presented game is a game of draw poker, five cards are initially selected and displayed to the player. The player then has the opportunity to hold none, one or more of those cards. The cards which are not held are replaced with other cards, and the resulting set of five cards are evaluated for winning combinations. To allow the player to select which cards to hold, the machine is configured to receive input from five push-button switches 20 corresponding to the five cards or card positions. Preferably, these buttons 20 are configured to display information to the player conveying that the push-button switches 20 are associated with that selection function. Thus, in one embodiment, the push-button switches 20 may be configured to display the text “HOLD.” This indicates to a player that if they depress a particular push-button switch 20, the card associated therewith will be “held” (and not discarded and then replaced with another card) during the game.

In the preferred embodiment, the push-button switches 20 are configured to display the “HOLD” text as a result of the association of that text with the push-button switch 20 and the illumination of the push-button switch 20 in a manner in which that text, and no other, is preferably visible. As indicated above, this is preferably accomplished by controlling the one or more lamps of the push-button switch 20, such as illustrated in FIG. 5(a).

Referring to FIG. 7, the same gaming machine 100 may be configured to present a slot type game. In one configuration, the machine is configured to display three simulated reels bearing symbols. The player may be permitted to provide input causing the machine to “spin” each of those simulated reels. The outcome of the game might be represented by the “stopping” position of each of those simulated reels.

As illustrated, in such a configuration, the three middle push-button switches 20 may be configured to display the text “SPIN.” This indicates to a player than if they depress any of those push-button switches 20, the simulated reel associated therewith will be spun.

In the preferred embodiment, the push-button switches 20 are configured to display the “SPIN” text as a result of the association of that text with the push-button switches 20 and the illumination of the push-button switch 20 in a manner in which that text, and no other, is preferably visible. As indicated above, this is preferably accomplished by controlling the one or more lamps of the push-button switch 20, as such illustrated in FIG. 5(b).

In this configuration, it is desirable for the end push-button switches 20 to not display any information. In that event, all of the lamps 70 may be illuminated in order to render all of the information associated with the button cover unreadable. In other words, at that time, the user perceives the push-button switch 20 as not displaying any information.

It will be appreciated that the gaming or other machine may include any number of input devices in accordance with the invention, and those input devices may be configured to display a wide variety of information. For example, input devices may include information such as “wager” or “bet,” “max bet,” “start” or the like, depending upon the associated function. Thus, it will be appreciated that the input device may be configured to display a wide variety of information and not just the information described specifically herein.

FIGS. 1 and 2 illustrate one configuration of a push-button electrical switch to which the principles of the invention may apply. Additional details of this switch are disclosed in U.S. Patent Application Publication US2004/0118669, published Jun. 24, 2004, the contents of which are incorporated entirely herein by reference. As disclosed therein, the particular configuration of the “push-button” actuating mechanism and the construction of the button has a number of advantages, including relating to replacement of the electrical switch thereof.

The principles of the invention may be applied to other types of push-buttons, however. For example, U.S. Pat. No. 5,543,594 discloses another type of push-button switch. However, such a push-button may be modified in accordance with the principles of the invention so that the push-button is configured to selectively display different information.

In general, the principles of the invention may apply to various input devices. These devices may comprise push-button type input devices of varying configurations, which devices are configured to translate a user “press” or other movement/motion/contact into an input, preferably in the form of an electrical signal. In addition, the input device may be of completely other types. In general, the invention may apply to a wide variety of user-input devices. These devices preferably include a user-engageable portion or body (such as the push-button cover of the switch described above), which user-engageable portion is configured to cause a signal generator to generate a signal (such as the electrical switch of the push-button switch described above). Information is associated with the input device, and preferably the user-engageable portion thereof, which information may be selectively displayed by illuminating that information with light in one or more colors.

For example, a joystick may include a user-engageable member in the form of a ball or handle which is configured to manipulate or trigger a signal generator (such as one or more electrical switches). In such an embodiment, the ball or handle may have associated information, and one or more lamps may be configured to cause certain of that information to be selectively visible to the user.

As another example, a “slider” type input device may include a use-engageable member in the form of a bar or handle. That bar or handle may be connected to a sliding electrical resistive device, such as via a stem or rod. The bar or handle may similarly have associated information, and one or more lamps may be configured to cause certain of that information to be selectively visible to the user. A rotatable switch may also include a knob which is back-lit and is configured to display information.

As described, the input device of the invention preferably has two or more different elements of information associated therewith, which information is configured to be selectively displayed via the one or more lamps. As in the example illustrated in FIG. 3, there may be three or more different elements of information associated with the device. Preferably, the information is in at least two colors.

As one aspect of the invention, the information which is associated with the input device may be changed. For example, in the case of the push-button switch 20 described above, the lens cap 24 may be changed.

It will be appreciated that the color(s) of the information and emitted light may be chosen in a variety of combinations to achieve the desired effect. For example, the button cover or other element with which the information is associated may be generally clear or transparent and the elements of information may be in color. Also, the button cover or other element may be of a particular color and the information may be of one or more colors, which colors, when taken together and along with the color of the emitted light, create the desired effect. It is noted that in such combinations, it is desired that certain of the information be readily visible or readable. Other of the information may not be “invisible,” but preferably is sufficiently less visible to the user that the desired information is primarily or more prominently visible.

As indicated, the at least one input device is preferably utilized to provide an input to a gaming machine or similar device, where the provided input may correspond to at least two different functions or features of the gaming machine. For example, an input from the device may correspond to a first function of a first game presented by the machine (such as a “spin” function of a slot-type game) and a second function of a second game presented by the machine (such as a “hold” or “draw” function of a video poker game).

Preferably, at least one controller is provided for controlling the input device, and more particularly, the one or more illumination devices. For example, in the case of the switch 20 described above, and LED controller may be provided for selectively controlling which of the LEDs are illuminated (or what color(s) the LED emits when the LED is capable of emitting light in different colors). In one embodiment, one or more controllers are associated with the gaming machine (such as located in the machine or remotely, at server). The controller may be used to transmit a signal to the input device (directly, to a secondary general input device controller, or a specific controller for the input device) which is used to configured the input device. For example, if a player elects to play the game of video poker, the gaming machine controller may send a signal to the controller(s) of the input devices instructing that the input devices be configured for that game (such as by causing the input devices to be illuminated in a manner causing the “HOLD” or “DRAW” information or the like to be rendered visible to the player). In this manner, the input device(s) of the gaming machine can be automatically reconfigured, thus changing the configuration of the machine.

FIG. 2 illustrates an embodiment of the invention where the one or more LEDs are individually mounted to one or more sockets and controlled from one or more remote controllers. In another embodiment, the one or more LEDs may be part of an integrated board. For example, a small processor or control board may support the one or more LEDs. The board may be used to control the one or more LEDs, and the board may be connected to a single power source (and then be configured to selectively power the one or more LEDs associated therewith). In one embodiment, a power supply voltage may be utilized to control which of the LEDs are illuminated or the color of the light emitted thereby. For example, where three LEDs are associated with a common control board, a supply of 1V by the board may cause one of the LEDs to illuminate, a supply of 2V may cause two of the LEDs to illuminate, and a supply of 3V may cause all three LEDs to illuminate.

In one configuration, at least the “illumination” portion of the input device (such as the controller and integrated one or more LEDs or other devices) may be configured as a peripheral device. For example, the LED/controller combination of the input device may be configured as a USB type device, or a serial or parallel communication based device which is associated with the gaming or other controller as a peripheral.

In one embodiment, “illumination” control communications for configuring the input device may alternatively be accomplished wirelessly. For example, the control board with which the one or more LEDs are associated may be associated with or include (such as integrated on the board) a receiver or transceiver. The control board may thus be configured to receive control instructions from remote location via a wireless communication transfer (which may be accomplished using various wireless communication schemes, protocols and technology, such as infrared and radio-frequency, including BlueTooth™ or 802.xx or the like). In such event, control instructions might be transmitted from the gaming controller in the machine, or a remote device, such as a central server.

This particular configuration of input device has the advantage that current non-configurable input devices may be more easily replaced. While gaming machines currently include power and signal paths to the non-configurable input devices, because the devices are not configurable, no control instruction wiring is present. Use of a wireless version of the input device of the invention does not require that the gaming machine wiring be modified to connect to or otherwise accommodate wired control connections to the input device. Instead, no such wired connections are necessary and the control instructions may be sent, as described above, wirelessly. In that instance, a configurable input device of the invention may simply be “plugged-in” in replacement of a current non-configurable device.

Numerous advantages are realized by the invention. First, it will be appreciated that a single configuration of an input device of the invention may be changed so as to display different information at different times to a user. In the context of gaming machine, this allows the input devices to be used in conjunction with the presentation of different games, where inputs from the input devices are associated with different functions of different games.

One advantage to the invention is that the cost of manufacturing the input device is relatively low. As indicated, the input device of the invention may have one or more elements in common to a standard push-button. For example, one solution to the problem referenced above in the Background might be to display game information and receive input through a touch-screen. Such screens, however, are often expensive and are not user-friendly.

Another aspect of the invention is color-codeable input devices and methods of using such devices. In one embodiment of a method, input devices are color-coded to provide information regarding the input devices, such as associated functions thereof, and/or for aesthetic purposes. As detailed below, the input devices may be color-coded in a variety of ways, including by displaying a particular color or having an appearance of a particular color, such as by emitting light of a particular color. In a preferred embodiment, the input device is configured to display at least two different or discrete colors at different times, whereby the configuration or appearance of the input device may be changed.

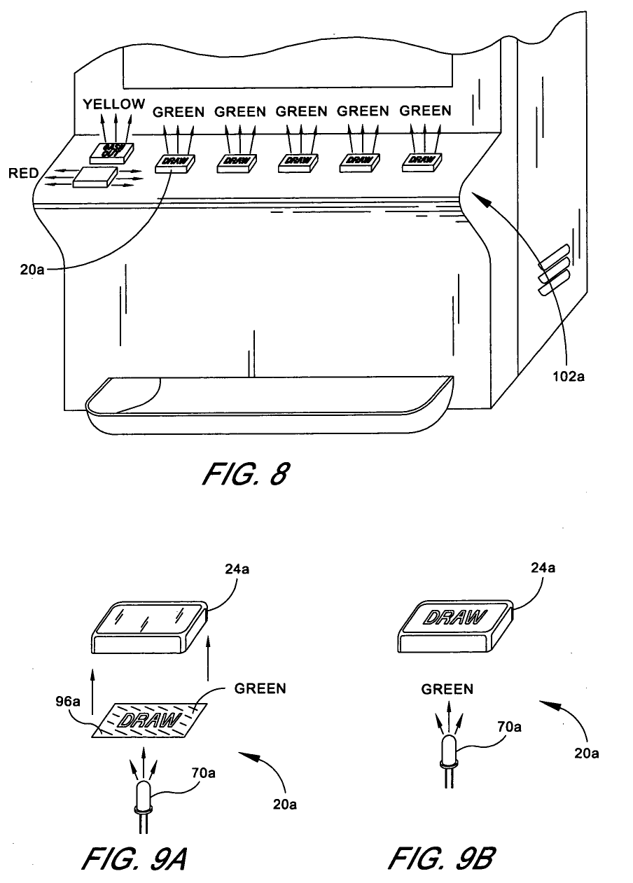

FIG. 8 illustrates one application for color-coded input devices. As illustrated, a gaming machine 100a has a plurality of input devices 20a. In one embodiment, the input devices 20a are push-type buttons, though they could be other types of devices such as rotatable knobs and the like, as described above.

Each input device 20a is configured to display at least one particular color, and preferably at least two different or discrete colors at different times. In a preferred embodiment, each input device 20a is configured to emit light, a color of which is associated with a particular function of the input device. For example, and without limitation, inactive input devices may be configured to emit “red” light. Active “play” buttons may be configured to emit “green” light. Wagering and subsidiary function input devices (such as a “bet” and/or “cash-out” button) may be configured to emit “yellow” light.

The particular color emitted by an input device may vary and may be dependent upon a number of factors. For example, the particular color(s) may depend solely upon the function of the input device. The particular color(s) may also depend upon the type of game (or other application with which the input device(s) are associated) and/or the “audience.” For example, Asian game players tend to favor “red” and “gold” colors, and thus active play buttons may be one of such colors (instead of green). On the other hand, Europeans and Americans associate “green” with “go” and “red” with “stop,” and thus active play input devices may be configured to emit green light and inactive input devices may be configured to emit red light.

Each input device may be configured in various fashions. As indicated, the input devices may be push-type buttons similar to those described above. Referring to FIG. 9A, in one embodiment, the input device 20a may include a lens or button cap 24a. A colored plate 96a may be associated with the lens cap 24a. A lamp 70a, such as a white LED light, is preferably configured to illuminate the colored plate 96a, thus causing the input device 20a to emit light of a particular color.

In this configuration, the color of the plate 96a and the color of the light emitted by the lamp 70a determine the color of light emitted by the input device. Thus, the color of the emitted light may be changed by changing either the plate 96a and/or the color of light emitted by the lamp 70a. For example, if the plate 96a is blue, if the lamp 70a emits white light, the input device will emit blue light. If the lamp 70a emits yellow light, then the input device will emit green light. In one embodiment, the lamp 70a may be configured to emit light of more than one discreet color, or more than one lamp 70a may be utilized, permitting the color of emitted light to be changed without changing the physical configuration of the input device 20a.

FIG. 9B illustrates another embodiment input device 20a where at least one lamp 70a is configured to illuminate a lens cap 24a. In this configuration, the color of light emitted by the lamp 70a and/or the color of the lens cap 24a (or a portion thereof) determines the color of emitted light. Once again, the lamp 70a may be configured to emit light of more than one color, or more than one lamp 70a may be utilized.

In either embodiment, the input device 20a may have associated information (such as text or the like). In one embodiment, color-coding may be utilized in conjunction with the above-referenced principles to make certain of the information visible. For example, the input device 20a may be configured to emit green light (thus color-coding the input device green) and at the same time that light may cause “draw/hold” text may be rendered visible.

In one embodiment, a key code may be displayed to a user of the input device. For example, in the case of a gaming machine, information may be displayed to a player on a display thereof or on a instruction page associated with the gaming machine. When a player initiates play of a game, for example, the display may show button and associated colors, indicating to a player which colors are associated with active, inactive or other button functions.

This aspect of the invention has particular applicability to devices which include more than one input device. Using the input devices of the invention, a gaming machine can easily be configured to present a variety of games. For example, a gaming machine may be provided with 20 input buttons. Various of those buttons may be color-coded green, red, yellow or other colors depending upon the particular game or games which are to be presented by the machine. The particular color coding may thus vary depending upon the particular use of the machine, which coding can easily be changed, including on a game-by-game basis.

In one embodiment, a player may be permitted to configure the input devices to display particular colors. For example, a player may be presented with a color-coding menu for the input devices and be permitted to select a desired configuration. The player might select, for example, a red-green-yellow coding configuration, or a red-yellow-white coding configuration, depending on the player's tastes and preferences.

The color displayed by the input devices may be controlled in a variety of manners. For example, the color of emitted light may be changed via a gaming or other controller, using wired or wireless communications, as described in greater detail above.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine including a plurality of a push-button type switches by which a player may provide input to said gaming machine, each push-button type switch including a body, a moveable push-button and at least one illumination device configured to selectively output light, said gaming machine configured to cause each of said push-button type switches to emit light in at least one of two discrete colors depending upon a function of said button.

2. The gaming machine in accordance with claim 1 wherein at least one of said push-button type switches is configured to emit red light and at least one of said push-button type switches is configured to emit green light.

3. The gaming machine in accordance with claim 1 wherein push-button type switches of said gaming machine which are associated with active game play are configured to emit light of a first color and push-button type switches of said gaming machine which are not used to play a presented game are configured to emit light of a second color.

4. The gaming machine in accordance with claim 1 wherein a color of light emitted by each push-button type switch is dependent upon at least one of the group consisting of: a color of said push-button, a color of a plate associated with said push-button and a color of light emitted by said at least one illumination device.

5. The gaming machine in accordance with claim 1 wherein the at least one illumination device comprises at least a first LED configured to emit light of a first color and a second LED configured to emit light of a second color.

6. The gaming machine in accordance with claim 5 wherein said first and second LEDs are located below said push-button within said body.

7. The gaming machine in accordance with claim 1 wherein each push-button type switch includes a wireless receiver and an illumination device controller, whereby instructions transmitted wirelessly to said wireless receiver of each push-button switch cause the controllers thereof to control said at least one illumination device of each push-button type switch to emit light of said at least one first or second color.

8. The gaming machine in accordance with claim 1 wherein said gaming machine includes a master controller and including a push-button type switch controller, and wherein said master controller is configured to transmit instructions to said push-button type switch controller regarding a color code configuration for said push-button type switches and said push-button type switch controller is configured to cause each push-button type switch to emit light of said at least first or second color.

9. A gaming machine input device comprising a body and a moveable input, said moveable input configured to move between at least a first position and a second position, movement of said moveable input generating an input signal, said input device having at least one lamp configured to emit light in a first color and a second color, a color of light emitted by said lamp changeable depending upon an associated input function of said input device to said gaming machine.

10. The gaming machine input device in accordance with claim 9 wherein said moveable input comprises a push-button lens cap connected to an actuator, said actuator configured to actuate a switch.

11. The gaming machine input device in accordance with claim 9 wherein said first color is red and said second color is green.

12. The gaming machine input device in accordance with claim 9 wherein said lamp is a multi-color LED associated with a control board.
